(19) United States
(12) Patent Application Publication
(10) Pub. No.: US 2007/0085792 A1
(43) Pub. Date: Apr. 19, 2007

(54) DISPLAY DEVICE AND GRAY-SCALE VOLTAGE GENERATING DEVICE THEREOF

(76) Inventor: Ching-Wu Tseng, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/306,631

(22) Filed: Jan. 5, 2006

(30) Foreign Application Priority Data
Oct. 14, 2005 (TW) 94135846

(51) Int. Cl. G09G 3/36

(52) U.S. Cl. 345/89

(57) ABSTRACT

A display device and a gray-scale voltage generating device for the display device are provided. The gray-scale voltage generating device includes a reference voltage source, a curve-shifting control unit, and a gray-scale voltage output unit. By correcting the output voltage of the curve-shifting control unit, the devices are able to shift the Gamma curve of the gray-scale voltage output unit. Therefore, the original Gamma curve can be shifted without having distortion.

### CROSS-REFERENCE TO RELATED APPLICATION

This application claims the priority benefit of Taiwan application serial no. 94135846, filed on Oct. 14, 2005. All disclosure of the Taiwan application is incorporated herein by reference.

### BACKGROUND OF THE INVENTION

1. Field of Invention

The present invention relates to a display device and a gray-scale voltage generating device thereof. More particularly, the present invention relates to a display device and a gray-scale voltage generating device which is able to shift the Gamma curve without distortion.

1. Description of Related Art

Most applications of the conventional Cathode Ray Tube (CRT) display devices have been replaced by a variety of flat panel display devices recently. The most common flat panel displays include the Liquid Crystal Displays (LCD), the Organic Light Emitting Diode (OLED) displays, the Plasma Display Panels (PDP), and so on. The flat panel displays generally have a gray-scale voltage generating device for providing a plurality of gray-scale voltages at different levels. The OLED display is illustrated below as an example.

The sub-pixels of both the OLED display and the LCD can be driven by the active matrix driving method. The former OLED display displays different gray-scales by controlling the current flowing through the organic light emitting diodes, while the latter usually drives the liquid crystal display panel by means of polarity reversal and using the voltage difference for determining the gray-scales. However, for the liquid crystal material which cannot be used as a light source, a backlight source should be used in combination with the voltage difference at both ends of the liquid crystal for determining the light transmittance of the liquid crystal and thereby producing different gray-scales.

Among the newer generation of display systems, the OLED display is a self-emitting light source and does not need a backlight board. In addition, its gray-scales are determined by the density of the charges flowing through the OLED, or its brightness is determined by the conducting duration of the diode. FIG. 1 is a circuit diagram of a display unit (sub-pixel) of a conventional OLED display. Referring to FIG. 1, in the conventional method for driving the OLED display, a plurality of different voltages are applied to the gate of the driver transistor T2 and thus the current flowed through the OLED is controlled. When a switch transistor T1 is turned on through a scan signal SR, the gray-scale voltage output from a source driver (not shown) is sent to the gate of the driver transistor T2, and is stored in the storage capacitor C_{sg}. The drain-source current ISD of the driver transistor T2 is able to be determined according to the gray-scale voltage stored in the storage capacitor C_{sg}, which results in the OLED producing different brightness.

When (voltage VPP—gray-scale voltage)>threshold voltage Vₜₕ of the driver transistor T2, the driver transistor T2 is on and the diode is emitting light. In other words, different gray-scale voltages shall result in different on-resistances of the driver transistor, so that the brightness can be controlled by the gray-scale voltages. But it is difficult to maintain the threshold voltages of the driver transistors on different display panels to be the same; therefore, it is likely that they have some discrepancies. As a result, during manufacturing of the display device, there must be some deviations which cannot be avoided in the threshold voltages of the driver transistors on the display panels which are manufactured in different processes. Consequently, the brightness of display panels will be different because of the deviations in the threshold voltages of the driver transistors on the different display panels, regardless of the degree of accuracy of the gray-scale voltage output from the source driver. In the more severe cases, it is even possible that portion of the display panel shall suffer from electrical leakages.

The conventional method for solving the aforementioned problem is to modulate the gray-scale voltage output from the source driver for compensating the deviations in the threshold voltages. FIG. 2 is a circuit block diagram of a conventional OLED display 20, which includes a Gamma correction circuit 21, a gray-scale voltage generator 23, and a source driver 25.

FIG. 3 shows a conventional method of correcting a Gamma curve. Referring to FIGS. 2 and 3 simultaneously, aimed at the display property of the selected display panel, manufacturers are able to correct the Gamma curve (i.e., the corresponding relation of the image data and the gray-scale voltage) appropriately by modulating the Gamma correction circuit 21, i.e., modulate the levels of the output Gamma voltages V_{G1}-V_{Gn}. The gray-scale voltage generator 23 then generates further more gray-scale voltages V_{g1}-V_{gm} having different levels according to the Gamma voltages V_{G1}-V_{Gn} output from the Gamma correction circuit 21. The source driver 25 selects a corresponding gray-scale voltage from the gray-scale voltages V_{g1}-V_{gm} according to the received image data, to drive the display panel 26.

With regard to the display panels of the same type, although having similar display properties, there must be some deviations in the threshold voltages of the drive transistors on different display panels. Hence, the corrected Gamma curve 31 should be shifted appropriately (without changing the original shape) so as to compensate for the deviations in the threshold voltages. The conventional method is to modulate the Gamma correction circuit 21 again for obtaining the compensation. But the voltages on a plurality of nodes must be modulated respectively at the same time in order to increase (or decrease) the output gray-scale voltages V_{g1}-V_{gm} by one potential difference dV₁-dVₘ respectively. Thus the previously-corrected Gamma curve is shifted without distortion. The potential differences dV₁-dVₘ should be equal to each other in theory. However, in reality, there are some discrepancies between the potential differences dV₁-dVₘ. Since the previously corrected Gamma correction circuit 21 has to be modified, the formerly-corrected Gamma curve thus must be distorted.

### SUMMARY OF THE INVENTION

Accordingly, the objective of the present invention is for providing a display device and a gray-scale voltage generating device thereof, which can be used for providing a plurality of gray-scale voltages to the display driver in a display device and for shifting the previously-corrected Gamma curve according to demand without distortion.

Based on the above and other purposes, the present invention provides a gray-scale voltage generating device, which includes a reference voltage source, a curve-shifting control unit and a gray-scale voltage output unit. The reference voltage source is able to provide a plurality of original reference voltages. The curve-shifting control unit is electrically coupled to the reference voltage source, and it can shift the level of the received original reference voltage by a shift voltage and output a plurality of shifted reference voltages. The gray-scale voltage output unit is also electrically coupled to the curve-shifting control unit; and it can generate the gray-scale voltages according to the shifted reference voltages and output them to the display driver, in which the amount of shift up and down of the Gamma curve of the gray-scale voltage output unit can be determined through the amount of modulation of the shift voltage.

In the gray-scale voltage generating device described according to an embodiment of the present invention, the aforementioned curve-shifting control unit further includes a plurality of adders for adding a shift voltage to a plurality of received original reference voltages, respectively, so as to output a plurality of shifted reference voltages.

In the gray-scale voltage generating device described according to an embodiment of the present invention, the aforementioned gray-scale voltage output unit includes a Gamma correction circuit and a gray-scale voltage generator. The Gamma correction circuit is electrically coupled to the curve-shifting control unit, and it generates a plurality of Gamma voltages according to the shifted reference voltages and outputs them to the gray-scale voltage generator. The gray-scale voltage generator is electrically coupled to the Gamma correction circuit; and it can also include a resistor string, for dividing the received Gamma voltages and generating the gray-scale voltages.

On the other hand, the present invention provides a display device, which includes a display panel, a display driver, and the foregoing gray-scale voltage generating device. The gray-scale voltage generating device is able to receive the shifted reference voltages, to modulate the multiple gray-scale voltages, and to output them to the display driver. Subsequently, the display driver drives the display panel, which can be a LCD panel or an OLED display panel.

In the conventional display driver, the Gamma curve is corrected in a complicated manner (by modulating a plurality of nodes respectively). In such a case, the original Gamma curve could be distorted. The present invention is able to shift the Gamma curve according to demand conveniently because it directly shifts the original reference voltages provided by the reference voltage source without modifying the original settings. At the same time, the previously-corrected Gamma curve shall not be distorted, and the deviations in the threshold voltages of the driver transistors for different batches of display panels can be compensated. As a result, the product yield is increasedduring mass production.

In order to the make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the present invention as claimed.

### BRIEF DESCRIPTION OF THE DRAWINGS

The accompanying drawings are included to provide a further understanding of the present invention, and are incorporated in and constitute a part of this specification. The drawings illustrate the embodiments of the present invention and, together with the description, serve to explain the principles of the present invention.

FIG. 1 is a circuit diagram of a display unit (sub-pixel) of a conventional OLED display.

FIG. 2 is a circuit block diagram of a conventional display.

FIG. 3 shows a conventional method for Gamma correction.

FIG. 4 is a circuit block diagram of an embodiment of the present invention.

FIG. 5 is a detailed circuit diagram of a gray-scale voltage generator for an embodiment of the present invention.

FIG. 6 is a circuit block diagram of another embodiment of the present invention.

FIG. 7 shows a correction method of the Gamma curve of the embodiments of the present invention.

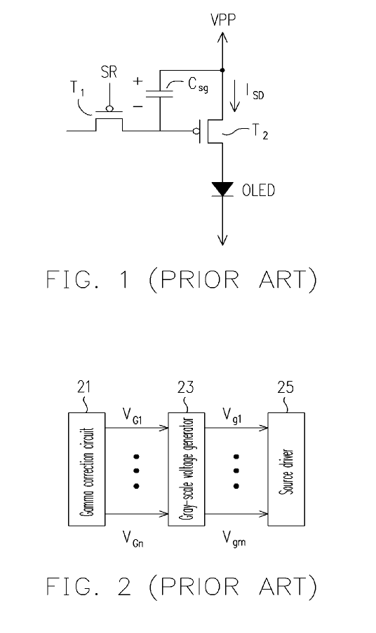

### DESCRIPTION OF THE EMBODIMENTS

The LCD panel and the OLED display panel shall be taken as examples of the display panels. And the source driver shall be taken as an example of the display drivers for the sake of clarification of the embodiments, in which t, i, n and m are all integers greater than 1.

FIG. 4 is a schematic view of an embodiment of the present invention. A display 400 of the present invention includes a gray-scale voltage generating device 410, a source driver 450, and a LCD panel or an OLED display panel (not shown). The gray-scale voltage generating device 410 includes a reference voltage source 420, a curve-shifting control unit 430, and a gray-scale voltage output unit 440. Furthermore, the gray-scale voltage output unit 440 includes a Gamma correction circuit 441 and a gray-scale voltage generator 442.

In an embodiment of the present invention, the reference voltage source 420 could be electrically coupled to the curve-shifting control unit 430. The Gamma correction circuit 441 is electrically coupled between the curve-shifting control unit 430 and the gray-scale voltage generator 442. The gray-scale voltage generator 442 is then electrically coupled between the Gamma correction circuit 441 and the source driver 450. Then the source driver 450 is able to drive the LCD panel or the OLED display panel.

In an embodiment of the present invention, the reference voltage source 420 provides a plurality of original reference voltages Vₛ₁-Vₛₜ to the curve-shifting control unit 430; then the curve-shifting control unit 430 shall provide a plurality of shifted reference voltages V_{R1}-V_{Ri} according to a plurality of original reference voltages Vₛ₁-Vₛₜ and a shift voltage V_{GB}. Subsequently, the Gamma correction circuit 441 shall provide a plurality of Gamma voltages V_{G1}-V_{Gn} according to the shifted reference voltages V_{R1}-V_{Ri}. Finally, the gray-scale voltage generator 442 shall provide a plurality of gray-scale voltages V_{g1}-V_{gm} according to the Gamma voltages V_{G1}-V_{Gn}.

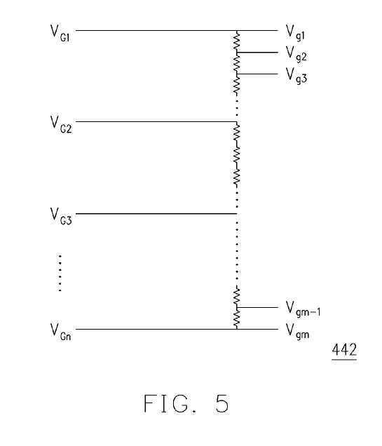

Referring to FIG. 5, it is a detailed circuit diagram of the gray-scale voltage generator 442. The gray-scale voltage generator 442 includes a resistor string used for dividing the Gamma voltages V_{G1}-V_{Gn} provided by the Gamma correction circuit 441 to output the gray-scale voltages V_{g1}-V_{gm}. The source driver 450 shall receive the gray-scale voltages V_{g1}-V_{gm} and output a corresponding gray-scale voltage according to the image data signal received by the display 400, i.e., the source driver 450 shall output the gray-scale voltages V_{g1}-V_{gm} to the storage capacitors of each sub-pixel on the display panel, and control the drain-source current of the driver transistor in the sub-pixels accordingly, and thereby the brightness of the sub-pixels can be controlled.

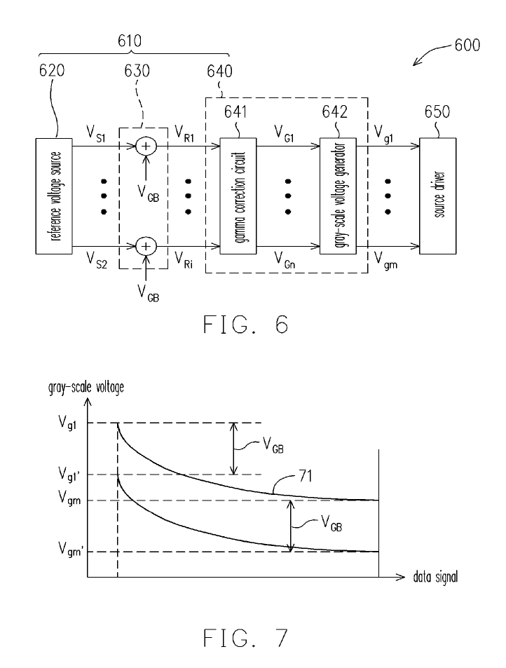

Referring to FIG. 6, it is a schematic block diagram of another embodiment of the present invention. FIG. 7 shows a method of correction of the Gamma curve of the present invention. Referring to FIGS. 6 and 7 simultaneously, the display 600 of the present invention includes a gray-scale voltage generating device 610, a source driver 650, and a LCD panel or an OLED display panel, in which the gray-scale voltage generating device 610 includes a reference voltage source 620, a curve-shifting control unit 630, and a gray-scale voltage output unit 640. The gray-scale output unit 640 further includes a Gamma correction circuit 641 and a gray-scale voltage generator 642. The display panel further includes a plurality of sub-pixels, each of which is driven by the source driver 650 correspondingly.

The electrical coupling relationships and transformations among a plurality of voltages for the display 600 are similar to the electrical coupling relationships and transformations among a plurality of voltages in the display 400, so they will not be described in further details herein. The aforementioned electrical coupling relationships and transformations are between the display 600, the gray-scale voltage generating device 610, the source driver 650, and the display panel respectively, and are between the reference voltage source 620, the curve-shift control unit 630, the gray-scale voltage output unit 640, the Gamma correction circuit 641, the gray-scale voltage generator 642, and a plurality of pixels, respectively.

The curve-shifting control unit 630 includes a first adder 631 and a second adder 632, which can be used for adding (or subtracting) the level of the shift voltage V_{GB} to (or from) the levels of the original reference voltages Vₛ₁ and Vₛ₂ respectively, i.e., the levels of the original reference voltages Vₛ₁ and Vₛ₂ are shifted by a shift voltage V_{GB} simultaneously and the shifted reference voltages V_{R1} and V_{R2} are outputted. Subsequently, the Gamma correction circuit 641 receives the shifted reference voltages V_{R1} and V_{R2} from the curve-shifting control unit 630 and divides them for outputting the Gamma voltages V_{G1}-V_{Gn} to the gray-scale voltage generator 642. The gray-scale voltage generator 642 then receives the Gamma voltages V_{G1}-V_{Gn} and divides them via its own resistor string for generating the gray-scale voltages V_{g1}-V_{gm}. Therefore, the levels of the gray-scale voltages V_{g1}-V_{gm} shall have the shifting of the shift voltage V_{GB} simultaneously without affecting the Gamma curve 71 previously set by the Gamma correction circuit 641. As a result, the Gamma curve 71 can be shifted by a distance of a shift voltage V_{GB} without distortion.

Referring to FIG. 7, the Gamma curve 71 can be shifted up and down by a distance of a shift voltage V_{GB} without changing its original shape. Thus the method of correction of a curve shall be simplified; and therefore the product yield will be increased during mass production.

As described above in the curve-shifting control units 430 and 630 of the present invention, the original reference voltages V_{S1}-V_{St} are modulated for generating a plurality of shifted reference voltages V_{R1}-V_{Ri} with the same voltage variation (V_{GB}). The shifted reference voltages V_{R1}-V_{Ri} are then outputted to the Gamma correction circuits 441 and 641 for generating the Gamma voltages V_{G1}-V_{Gn}, which are then inputted into the gray-scale voltage generators 442 and 642 for obtaining the gray-scale voltages V_{g1}-V_{gm} through its processing. As a result, the shifted Gamma curve can be obtained.

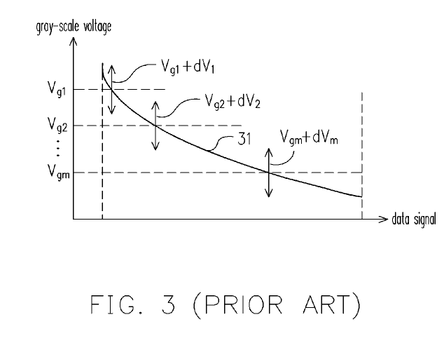

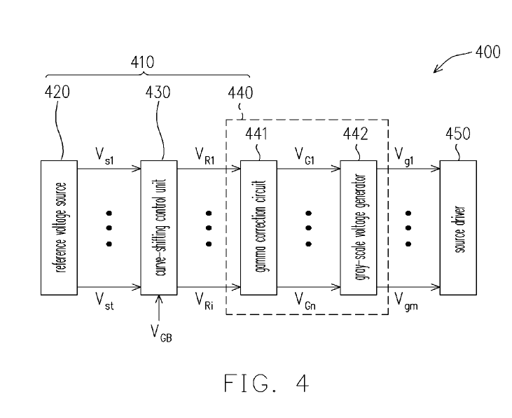

In comparison of FIGS. 7 and 3, the nodes of the Gamma curve 31 in FIG. 3 are corrected respectively, and the degree of correction of each node is possibly different, which will cause the distortion of the curve and the performance characteristics of the display panel will thereby be affected. On the contrary, the gray-scale voltage generating device of the present invention will control the shift voltages V_{GB} of the curve-shifting control units 430 and 630 to achieve the effects of the corrected Gamma curve 71 in FIG. 7. Therefore, the method of correction of the curve can be simplified without having any distortion.

It will be apparent to those skilled in the art that various modifications and variations can be made to the structure of the present invention without departing from the scope or spirit of the present invention. In view of the foregoing, it is intended that the present invention cover modifications and variations of this invention provided they fall within the scope of the following claims and their equivalents.

What is claimed is:

1. A gray-scale voltage generating device for providing a plurality of gray-scale voltages to a display driver, comprising:
a reference voltage source for providing a plurality of original reference voltages;
a curve-shifting control unit coupled to the reference voltage source for shifting the levels of the received original reference voltages by a shift voltage to output a plurality of shifted reference voltages; and
a gray-scale voltage output unit coupled to the curve-shifting control unit for generating the gray-scale voltages according to the shifted reference voltages and outputting the gray-scale voltages to the display driver, wherein the Gamma curve of the gray-scale voltage output unit is shifted by modulating the shift voltage.

2. The gray-scale voltage generating device in claim 1, wherein the curve-shifting control unit comprises a plurality of adders, for adding the shift voltage to one of the received original reference voltages, respectively to output one of the shifted reference voltages, respectively.

3. The gray-scale voltage generating device in claim 1, wherein the gray-scale voltage output unit comprises:
a Gamma correction circuit coupled to the curve-shifting control unit for generating and outputting a plurality of Gamma voltages according to the shifted reference voltages, and modulating the levels of the Gamma voltages; and
a gray-scale voltage generator coupled to the Gamma correction circuit for generating the gray-scale voltages according to the Gamma voltages and for outputting the gray-scale voltages.

4. The gray-scale voltage generating device in claim 3, wherein the gray-scale voltage generator comprises a resistor string for dividing the Gamma voltages to generate the gray-scale voltages.

5. A display device, comprising:
a display panel;
a gray-scale voltage generating device, used for correcting and outputting a plurality of gray-scale voltages, wherein the gray-scale voltage generating device receives a shift voltage for shifting the levels of the gray-scale voltages according to the shift voltage, and Gamma curve of the gray-scale voltage generating device is adjusted by modulating the shift voltage; and
a display driver coupled to both of the display panel and the gray-scale voltage generating device, for selecting a corresponding gray-scale from the gray-scale voltages according to a display data to drive the display panel.

6. The display device in claim 5, wherein the gray-scale voltage generating device comprises:
a reference voltage source for providing a plurality of original reference voltages;
a curve-shifting control unit coupled to the reference voltage source for shifting the levels of the original reference voltages according to the shift voltage, to output a plurality of shifted reference voltages; and
a gray-scale voltage output unit coupled to the curve-shifting control unit for generating the gray-scale voltages according to the shifted reference voltages and outputting the gray-scale voltages to the display driver.

7. The display device in claim 6, wherein the curve-shifting control unit comprises a plurality of adders for adding the shift voltage to one of the received original reference voltages, respectively, to output one of the shifted reference voltages, respectively.

8. The display device in claim 6, wherein the gray-scale voltage output unit comprises:
a Gamma correction circuit coupled to the curve-shifting control unit for generating and outputting a plurality of Gamma voltages according to the shifted reference voltages, and correcting the levels of the Gamma voltages; and
a gray-scale voltage generator coupled to the Gamma correction circuit for generating the gray-scale voltages according to the Gamma voltages and outputting the gray-scale voltages.

9. The display device in claim 8, wherein the gray-scale voltage generator comprises a resistor string for dividing the Gamma voltages to generate the gray-scale voltages.

10. The display device in claim 5, wherein the display panel comprises a liquid crystal display panel.

11. The display device in claim 5, wherein the display panel comprises an organic light emitting diode display panel.

12. A method for driving a display panel with a gray-scale voltage generating device, comprising:
providing a plurality of reference voltages;
shifting the levels of the reference voltages by a shift voltage and outputting a plurality of shifted reference voltages;
generating a plurality of gray-scale voltages according to the shifted reference voltages and outputting the gray-scale voltages; and
selecting a corresponding gray-scale from the gray-scale voltages according to a received display data to drive the display panel;
wherein Gamma curve of the gray-scale voltage generating device is shifted by modulating the shift voltage.

13. The method of claim 12, wherein the step of shifting the levels of the reference voltages comprises:
adding the shift voltage to one of the reference voltages respectively and outputting one of the shifted reference voltages respectively.

14. The method of claim 12, wherein the step of generating the gray-scale voltages comprises:
generating and outputting a plurality of Gamma voltages according to the shifted reference voltages, and modulating the levels of the Gamma voltages; and
generating the gray-scale voltages according to the Gamma voltages and outputting the gray-scale voltages.
